(19) United States
(12) Patent Application Publication
(10) Pub. No.: US 2014/0009496 A1
(43) Pub. Date: Jan. 9, 2014

(54) METHODS AND SYSTEMS FOR OBJECT BASED DATA MANAGEMENT

(71) Applicants: Kenneth CHAPMAN, Kitchener (CA); Daniel SCHNEIDER, Kitchener (CA); Jeremy AUGER, Kitchener (CA)

(72) Inventors: Kenneth CHAPMAN, Kitchener (CA); Daniel SCHNEIDER, Kitchener (CA); Jeremy AUGER, Kitchener (CA)

(73) Assignee: Desire2Learn Incorporated, Kitchener (CA)

(21) Appl. No.: 13/544,030

(22) Filed: Jul. 9, 2012

(51) Int. Cl. G09G 5/00; G06T 11/20

(52) U.S. Cl. 345/636; 345/440

(57) ABSTRACT

Methods and systems for object based data management and reporting involving graphical display of objects and related data. A method for object based data management including providing a chart showing a plurality of objects, retrieving object based data relating to each object, determining comparable data for the plurality of objects, and selectively graphically overlaying the comparable data on the chart. A system for physical object based data management including a data collection module adapted to retrieve object based data relating to each object, a data analysis module adapted to determine comparable data for the plurality of objects, and a display module adapted to selectively display the comparable data as a chart. In a particular case, the system and method may be used for tracking data relating to a classroom and students.

### FIELD

The present disclosure relates generally to data management and reporting. More particularly, the present disclosure relates to methods and systems for object based data management and reporting.

### BACKGROUND

Data management and reporting is an important aspect to most businesses, including governments and academia. Businesses are typically interested in determining metrics, statistics and other information relating to performance of employees, efficiency, profitability, etc. One of the issues often facing businesses in recent times has been an overflow of data or information. The challenge has become how to manage and present the accumulated data in a way that can be quickly understood and effectively used in an organization.

As a particular example, many educational institutions are also concentrating more on data reporting in order to accurately track, analyze and report the success of their students internally and externally. Many educational institutions and instructors track students' grades, attendance, participation and other factors. However, it can sometimes be difficult to access data without entry of some search key or other indicator of the physical object (for example, a student, in the educational context) on which the data is to be retrieved. As such, most data entry and review is conducted in an off-line mode. For example, typically for an instructor to know a student's grade, the instructor would need to work from memory, do a lookup via a website on a computer, or use paper records. It would be preferable for the instructor to obtain such information in real-time.

It is, therefore, desirable to provide improved methods and systems for data management and reporting.

The above information is presented as background information only to assist with an understanding of the present disclosure. No determination has been made, and no assertion is made, as to whether any of the above might be applicable as prior art with regard to the present invention.

### SUMMARY

Generally, the present disclosure relates to systems and methods for managing and reporting/displaying data related to objects—object based data management.

According to an aspect herein, there is provided a method for object based data management including: providing a chart showing a plurality of objects; retrieving object based data relating to each object; determining comparable data for the plurality of objects; and selectively graphically overlaying the comparable data on the chart.

In a particular case, the method may further include: allowing a user to select a specific object of interest; and displaying object based data for the specific object of interest.

In another particular case, the method may further include allowing a user to edit the object based data for the specific object of interest.

In yet another particular case, the chart may be a location based chart. In this case, the location based chart may be a seating chart.

In still yet another particular case, the method may further include analyzing the comparable data after the data is retrieved.

In some situations, the chart may be displayed on a network enabled device.

In still yet another particular case, the overlaying the comparable data comprises a visualization of the comparable data with respect to each physical object.

According to another aspect herein, there is provided a system for physical object based data management including: a data collection module adapted to retrieve object based data relating to each object; a data analysis module adapted to determine comparable data for the plurality of objects; and a display module adapted to selectively display the comparable data as a chart.

In a particular case, the data analysis module may be adapted to analyze the comparable data.

In another particular case, the data collection module may further include an input component adapted to collect data relating to the plurality of objects and store the data in a database.

In yet another particular case, the display module may be adapted to display the chart on a network enabled device.

In still yet another particular case, the display module may be adapted to receive input from a user accessing the system through a network enabled device.

According to another aspect herein, there is provided a system for automatic processing of attendance including: an input component adapted to capture data relating to students in a classroom; a data collection module adapted to retrieve and store data from the input component; and a data analysis module adapted to determine attendance data based on the captured data and pre-existing data relating to the students.

In a particular case, the input component may a camera.

In another particular case, the system may further include a display module adapted to display the attendance data in relation to a seating chart of the classroom.

In yet another particular case, the data analysis module may be adapted to aggregate the attendance data for each student over a plurality of class sessions.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 illustrates a system for object based data reporting;

FIG. 2 is a flow chart of a method for object based data reporting;

FIG. 3 is a blank chart according to one embodiment;

FIG. 4 is a location based chart for object based data reporting;

FIG. 5 is an example of a graphical overlay on a chart for object based reporting;

FIG. 6 is an example of displaying specific elements for a object; and

FIG. 7 is another example of displaying specific element for a object.

### DETAILED DESCRIPTION

Generally, the present disclosure provides methods and systems for object based data management and reporting. In particular, the methods and systems are designed to collect data about an object, for example an employee, a student, a machine, a factory, and the like, and selectively display this data in a manner that is intended to be easy to view and understand by a user, for example in a graphical way. For example, the user may be shown a chart which has the data overlaid in a manner that is intended to make the data more accessible. In this disclosure, the word “chart” is intended to by used broadly, and is not meant to be restricted to a location chart, a graph, or other specific arrangement but may be any appropriate graphical representation of data.

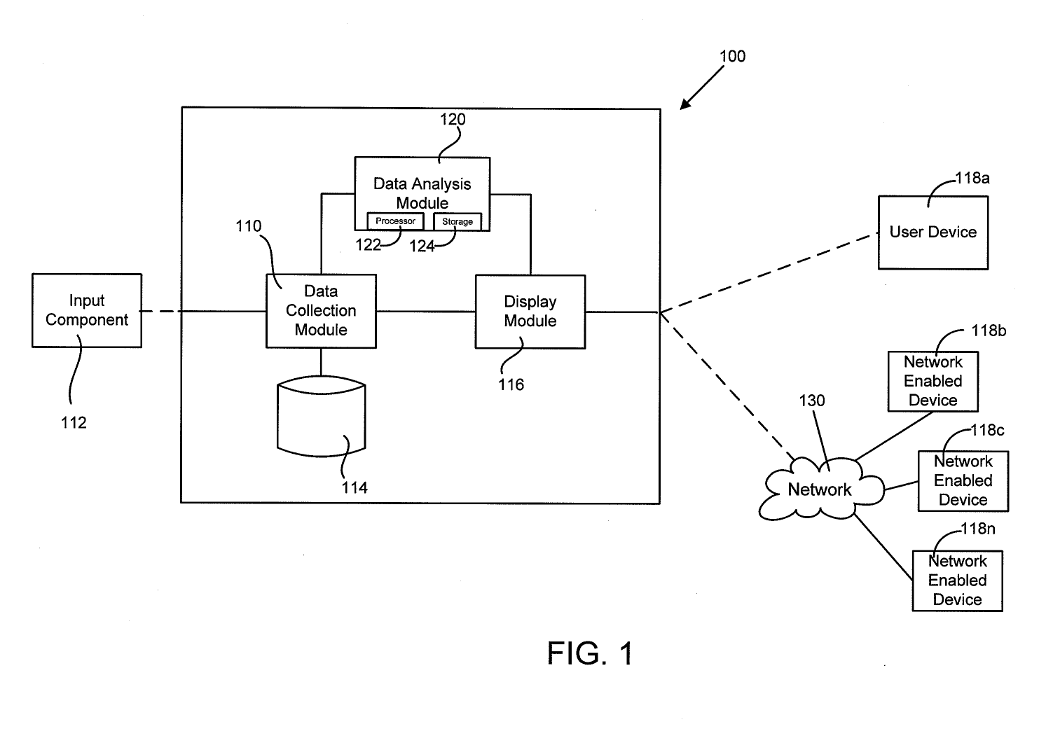

FIG. 1 illustrates an example of a system for object based data management and reporting 100. The system 100 includes a data collection module 110. The data collection module 110 may receive input from one or more of a variety of external input components 112, or may retrieve data stored within a database 114, data repository or from other systems or the like. The input received generally relates to one or more objects of interest. The data collection module 110 may include a chart sub-module (not shown) for allowing a user to generate or create a chart related to the objects of interest. For example, in a classroom setting, the objects may be the students enrolled in the class; the input component 112 may be at least one camera which takes a photo and/or video of the classroom to gather data on the students, for example, seating location (for creating a chart), attendance data or the like. It will be understood that the input component 112 may be any network connected device that is configured to interface with the system 100.

Using the example of attendance data, the at least one camera may be used to automatically create a chart showing all of the students in the class and also allow the system 100 to automatically take attendance by recognizing individuals in the class. In a particular case, the camera may recognize individuals through the student's classroom location, for example, if students have arranged seating, the camera can tell if a position is unoccupied. In another case, the camera may be able to recognize students through facial recognition software. A similar system may be adapted in a factory setting or in an office setting using cubicles where a camera could view and determine attendance. Other input components such as manual data entry or data entry through network links to other systems and databases may also be used to provide the data collection module 110 and database 114 with data. In some cases, the data may be received by the data collection module 110 but not necessarily stored in the database 114. The data collection module 110 is intended to have a flexible interface to allow for additional data sources to be operatively connected to the system to merge data and further customize the data available.

The data collection module 110 is also connected to a display module 116. The display module 116 may selectively display the data in the form of a chart, or may graphically overlay the data on a previously created chart. A user, using a device 118a, such as, for example, a personal computer, tablet, a mobile device, or other device may access the system 100 directly. In an alternative, the system 100 may be accessed by a user's network enabled device 118b, or a group of users' network enabled devices 118b, 118c to 118n, through a network 130 such as a local area network, a wide area network, or global network, such as the Internet. The network enabled devices may include computers, tablets, smart phones, and the like. It will be understood that the system 100 itself may include one or more servers and may be co-located or distributed.

The system 100 further includes a data analysis module 120. The data analysis module 120 receives data from the data collection module 110 and is configured to manage and analyze data, including, for example, aggregating data, determining comparable data, calculating statistical information based on the data, and the like, as further detailed below. The term “comparable data” is used to define data of a type that can be compared between various objects. For example, student scores on a test are a type of data that is used to compare a student with other students. The data analysis module 120 may include a processor 122 or alternatively be operatively connected to a processor that is external of the system 100.

The comparable data and/or analyzed and/or aggregated data may be stored within a storage component 124, which may be incorporated with the data analysis module 120. Alternatively, the storage component 124 may be separate from but operatively connected to the data analysis module 120. In a particular alternative, the storage component 124 may be included as part of the database 114. Further alternatively, the storage component 124 may be on a remote server (not shown) or the like.

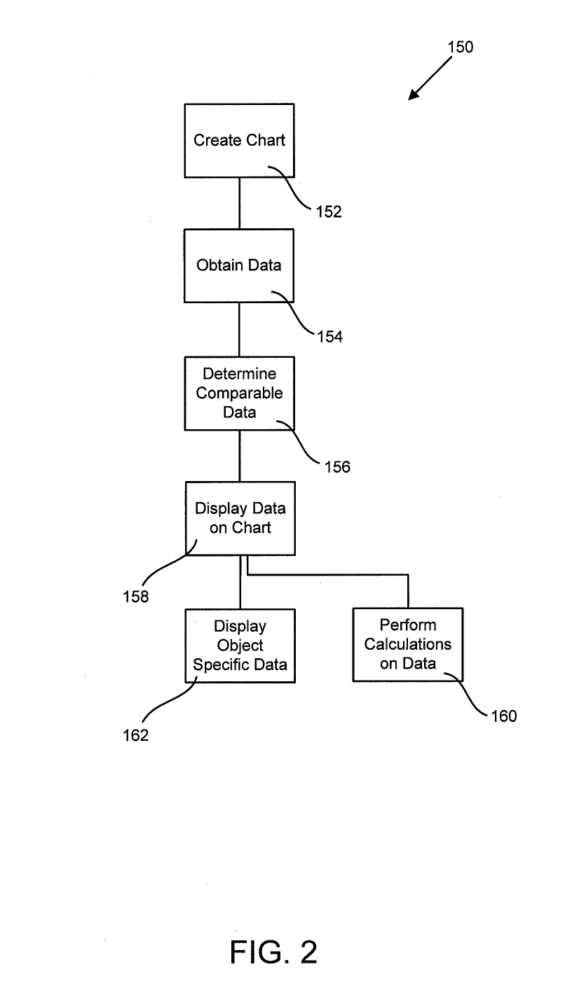

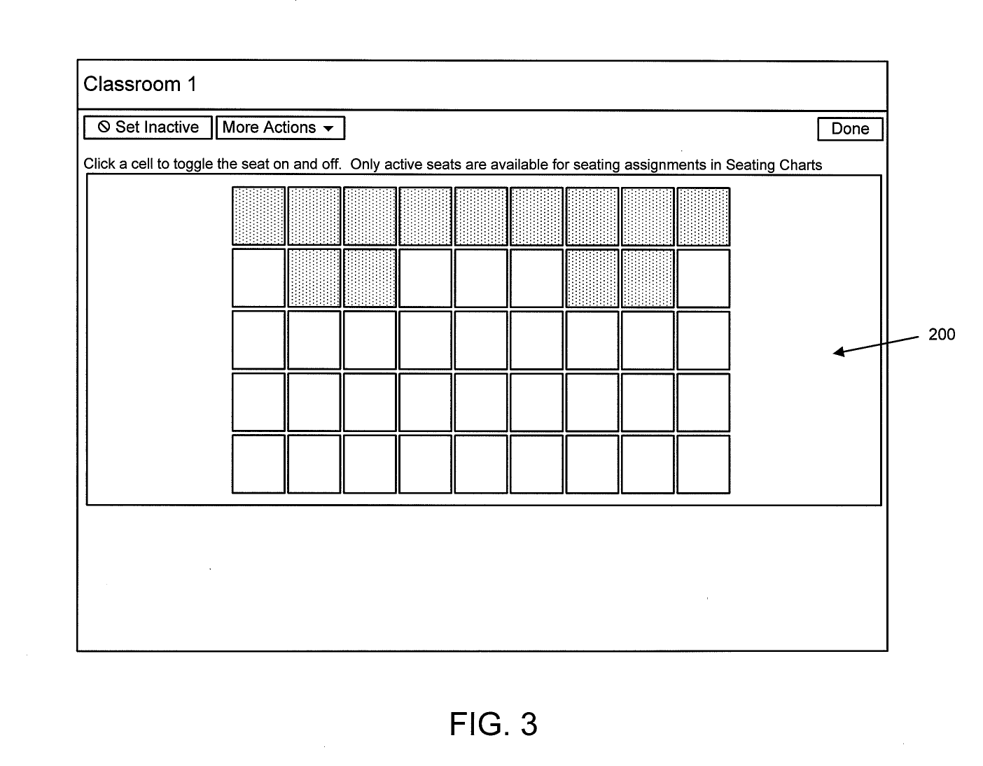

A method for object based data management and reporting 150 is shown in FIG. 2. The method starts with defining, creating or otherwise generating a chart 152. As noted above, this may be performed by the data collection module 110 above, either automatically or with user input. An example of a blank chart 200 is shown in FIG. 3. The blank chart 200 may be used in a location based data reporting system, wherein the position within the chart generally corresponds with a location of the object. Other chart representations may be formed in a similar fashion; the chart could represent machines within a factory, displayed by, for example, location, age, or efficiency rating. As another example, the chart representation may be created such that when the chart is populated with data, the data is sorted according to a predefined or selected characteristic of the data. For example, the chart may be represented such that students are arranged according to their names, respective grades, major, and the like.

In a particular example, the chart may be a seating chart. Each box may correspond to where a student or an employee is located. At the beginning of a class or a workday, a camera may take a snapshot or video of the seating area and identify absences by determining if a location is vacant. Further snapshots or videos could be taken later in the class or later during the day to identify if a student or employee was late and was in attendance later in the day or perhaps if a student or employee has left before the end of a class or workday.

After the chart has been defined, data to be displayed or reported on the chart may then be obtained 154. The data may be collected via the input component 112 or may have been previously collected and may be retrieved by the data collection module 110 from a database, either the database 114 within the system 100 or exterior but operatively connected to the system 100.

The data analysis module 120 then analyses or aggregates data and determines comparable data 156. The chart is intended to interact with reporting mechanisms in order to give the user a visualization of the data by displaying comparable data in an appropriate manner. Comparable data may be, for example, transactional data that can be stored and overlaid graphically on the chart.

The comparable data is then selectively displayed on the chart 158. The display module 116 is intended to produce a graphical or image-based representation of the objects and display overlaid data presented graphically in relation to location, using patterns, or other visualization of data.

After the comparable data is displayed, the user may request further analytics to be performed on the data 160 or may wish to display further data with respect to a specific object 162. Further analytics, such as filtering the comparable data or aggregating the data, may be performed by the data analysis module 120. Further data for a specific object may be stored in the database 114, the storage component 124 or may be collected by the data collection module through an input component such as a network connection to a third party database, prior to being displayed by the display module 116. According to some embodiments, the data analysis module 120 may, for example, determine attendance history for a specific student, group of students, or the like. As a further example, the data analysis module 120 may also determine a student's or group of students' attendance record in a corresponding class or classes.

In an example use, the chart can assist in situations of substitute teachers or doctors, who may not have significant data with respect to the people with whom they will be dealing. The user could review a chart of individuals and select a graphical overlay such as students in the class or patients within the next hour. The user could drill down for further data on a specific person to determine particular needs or information related to the person in question. The user could also use the data as a factor in deciding future actions. For example, a teacher could use the data in determining which student to call on for a specific question. As a further example, a teacher could also determine if a student is more consistently absent from one class than another.

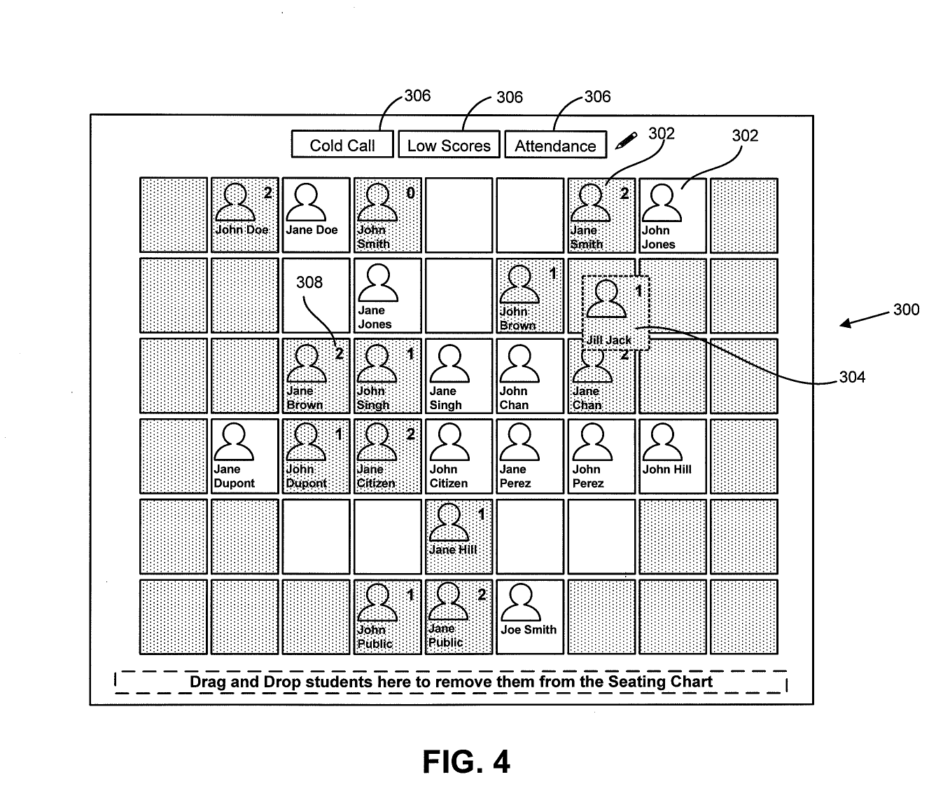

In a specific example of a system for object based data management and reporting, the chart may be a location based chart showing a virtual classroom that represents a physical classroom. The virtual classroom may define an approximate or even accurate representation of a classroom. As example classroom chart 300 is shown in FIG. 4. The layout may be changed or rearranged when individuals 302 move locations, for example, the professor may drag and drop an image of the student to a new assigned position 304.

The chart may further provide a selective display function, where a user could activate, for example a button 306a, 306b, and 306c, to overlay comparable data on the chart, wherein the data has been previously collected or is collected at the time the user presses the button. In this example, the instructor may wish to have further information regarding individual participation level, individual absences, individual grades, and the like. On selecting a data overlay, a further graphical representation may be displayed on the chart. For example, if attendance was selected, the number of attendances (e.g. attendance history) per individual 308 may be displayed beside a picture and/or name of the individual 302. If an individual has a number of absences above a predetermined threshold level of attendances, the number, the image of the individual and/or the individual's name could be highlighted or displayed in a predetermined colour (e.g., a different colour from other individuals). Other overlays may have unique features depending on the data involved. For example, some data may be represented numerically, other data may be represented using graphs, colours, size of object or any of various types of data representation. As an example, an individual's grade in a course or for a specific course objective or task may be displayed beside a picture and/or name of the individual 302.

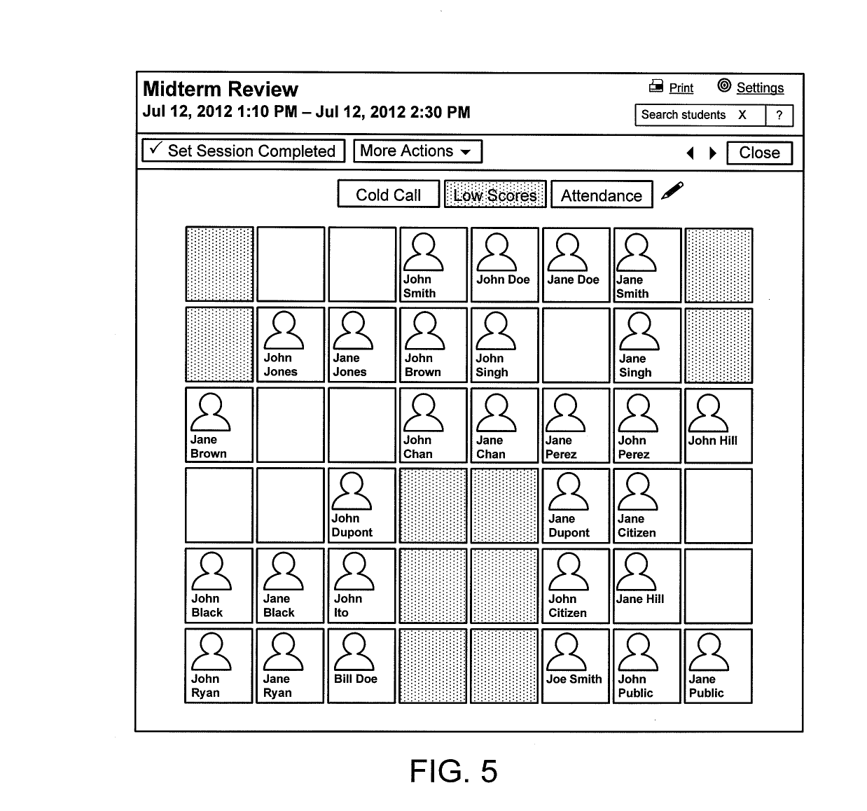

The data may also be filtered by the user by using the system 100. The user may select to view only certain objects with data within a filter. The filter may be selected once the user has seen the overlay for the plurality of objects or may be set prior to displaying the overall graphical overlay on the chart. As shown in FIG. 5, when a user selects the “low scores” filter, only those students having low scores (e.g., scores below a predefined or predetermined threshold, which could be fixed or variable, depending on, for example, statistical analysis) are displayed while the others are “grayed out”.

The chart may be updated in many ways depending on the method in which the user wishes to group the data. The chart may be grouped by, for example, geographical region or by employment department. The user may select to compare data per group. The data, collected by the data collection module 110, may be calculated per group by the data analysis module 120 and be displayed to provide an overall picture to the user.

The chart may be further integrated with other systems or components of the user's network enabled device. For example, the system 100 may be integrated with the user's calendar, when a calendar displays that it is time for a class, or a department meeting, the chart may be displayed to the user. The user would be able to review comparable data, such as attendances, during or prior to the start of the class. The system may be further integrated with a tablet or smart phone such that the chart is displayed on this device when it is time for a class.

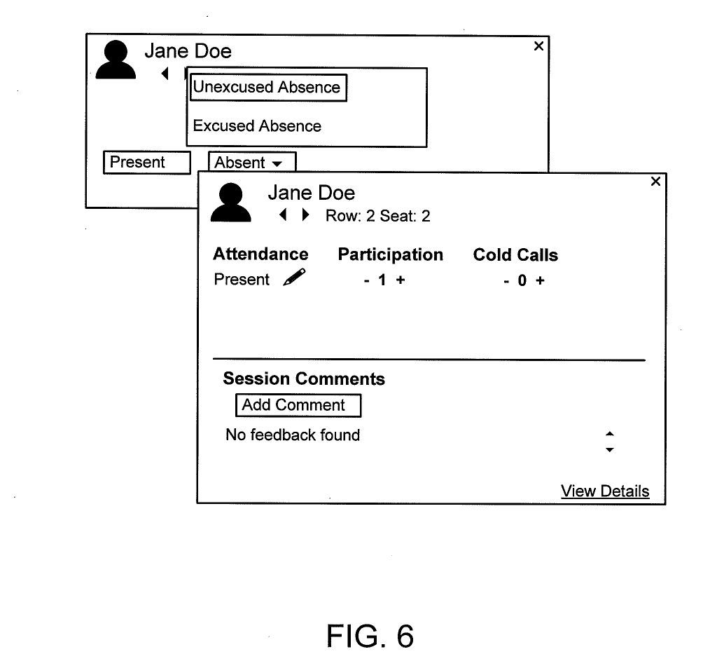

As shown in FIG. 6, the chart may further allow users to drill down and retrieve further information regarding a particular object. For example, in a classroom setting, the user, such as an instructor, may wish to view further information regarding a particular student. Once the system receives the request for further information on a particular object, the system may display further data on the chart or in another display window or page. In the student example, the user may wish to see the number of absences of a specific student and narrow the search by determining how many absences are excused compared to unexcused. The user may also be able to edit the information. As shown in FIG. 6, the user may wish to mark the student present, adjust the participation data, or add a comment as to why the student was absent. In another example, the user may be monitoring machinery and wish to update throughput or repair information by selecting the specific object and updating the information accordingly.

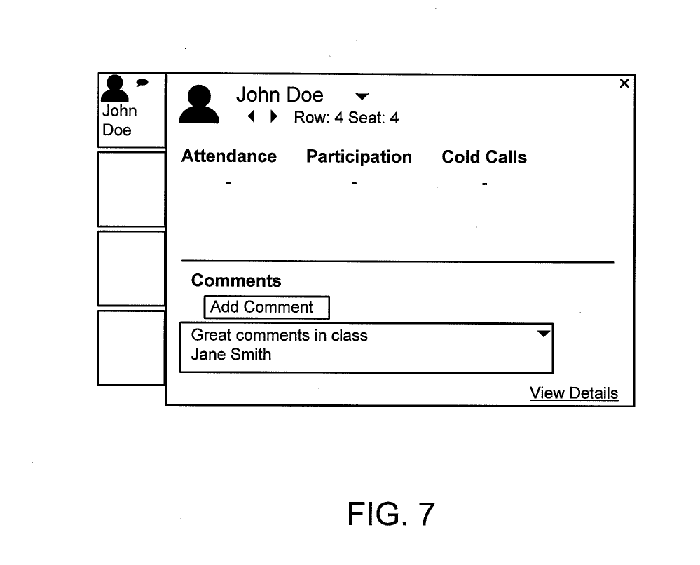

FIG. 7 shows a further example of obtaining specific data on one of the objects. The user may be presented with an overview of the student's attendance, participation and cold calls. The user may further add in comments regarding the student's participation in class. The comment may be automatically dated to be associated with a specific class date or may be running commentary on the student throughout the student's enrollment in the class.

Further detail, collected by the data collection module 110 from an input component 112 may be displayed with respect to the object. Statistical and other information may be collected by the data collection module 110 through interaction with input components 112 such as third party databases, previously stored user input, and the like. In some cases, the user may request that data related to a specific aspect of the object, for example in the case of a machine, the user may access a specific maintenance report, or in the case of a student, the user may access a specific midterm assignment or test.

In the classroom example, instructors may use the system 100 to track and review previous questions and responses made by students and compare number of correct answers on a graphical display. The instructor may then review specific students and the questions they were asked, the answers provided or other data which is intended to allow the instructor to make informed decisions and stay on top of what is happening with their students to be able to tailor their instruction to individuals. For example, the instructor may use such information to decide which students to call on, which subject matter to focus on, and the like.

In one example, the number of cold calls each student has received may be of interest to an instructor. Each time a student is asked a question the instructor could identify the student asked. The instructor may provide feedback to the system 100 to enter this data. For example, if the instructor is using a device with a touch screen, the instructor may need to only touch the chart in the appropriate location to add this information. If the system 100 (for example, via input component 112) has a recording ability the question and/or answer may be recorded and stored. The instructor could refer to this stored data when reviewing and determining grades for the students. The instructor may select to review the number of times a student had been called upon as well as notes or recordings with respect to the quality and information provided in the student's answer if this further information was stored by the instructor. The system 100 is intended to allow the instructor to overlay competencies and participation to know who to call on (or not call on) to achieve the best in-class experience or spread out discussion to all participants in a course.

In a further example, the system 100 may display information regarding assignments and extensions. The system may graphically display the number of assignments received from each student. If a student approaches an instructor in a class with a large number of students such that the instructor is less likely to know who the student is or recall specific data about past performance, the instructor can determine information via the system 100 prior to speaking with the student. If the student is requesting an extension on their assignment, the instructor can review the student's attendance, participation and/or other assignment marks to determine whether this student habitually requests extensions on assignments or instead may have a legitimate reason for requesting the extension. The instructor may use the system 100 to recognize the student's face, through an input component 112, such as a camera, or through images displayed on the chart. From the chart, the instructor may determine that the student has not attended the last few lectures and/or is reading the content for the online course right before exams or assignments are due. The instructor may decide not to grant the request and instead may mark the student at risk and place them on a remediation plan, for example, a plan that randomly assigns question sets each day for the student to stay on track with the course.

Users, for example, instructors, can select and modify what data is to be displayed either as comparable data graphically displayed on the chart or displayed when a specific object such as when an individual is recognized. For example, information an instructor may be able to view in relation to a specific student may include:
Attendance
Grades
Class related data—questions asked/answered, grades by assignment and the like
School related data—overall attendance data, other class attendance data, overall and other class grades and the like
Recent tweets, online posts, and the like
Missed deadlines, interventions taken with the student
Recent activity by the student
Health concerns (for example, allergies or the like)
Emergency contact information
Online profiles or blogs the individual has made public through their profile
Feedback the user has provided on the course, or questions they have posted
Other characteristics available through on-line or local sources.

As noted above, this information is intended to be displayed in addition to the image of the student to allow the instructor to have easy recognition between the information and the student in question.

Further, the system may also be used by instructors, supervisors, management of the like to determine if there is any user bias with respect to the objects represented. For example, a manager may determine that some students are being asked questions more frequently by the instructor and, as such, are performing better. This information can then be used to encourage the instructor to ask questions of a broader range of students. Trends such as these could be determined over various classes and/or sections of classes to determine if this is an instructor specific issue or a more general issue. The system may be able to further predict trends, based on the gathered data and implement solutions. As a simple example, students sitting in the front row may tend to perform better than those in the back row and the system would allow an instructor to encourage and track students to sit in the front row on a regular basis. In some cases, the system may also provide data to external applications for use in data aggregation and statistical analysis. As data is determined by the system 100, this data may be incorporated into larger statistical analysis systems with the ability to amalgamate the data from multiple incarnations of the system 100 to determine trends, for example, across schools, counties, states, countries or the like.

In some cases, the charts may also be compared with historical charts. For example, the user can select a particular graphical representation of comparable data and select, for example, the previous month or the previous year's similar graphical representation of comparable data to view how the data has changed, for example, from one semester to the next. The charts may also be used to compare various sections of related data. For example, the comparable data may be marks below a threshold in a specific class and the user may select to compare the various sections of the class to see for example, if the number of low marks is equal across the various sections or if one section has outperformed the other sections.

As noted above, in some cases, the system 100 will interact with an input component 112, for example one or more webcams or embedded cameras (see FIG. 1). The camera(s) may be used to capture image data of, for example, the classroom or of students/individuals in the classroom. Once the image data is captured, the system 100 can retrieve profile pictures stored in the repository 114 or in another database the system 100 may access via the data collection module 110. The data analysis module 120 can then match the captured image with a related profile picture. Once matched, further information obtained from the profile may be displayed by the display module 116. For example, the instructor may then drill down to view further information, or the information may be selectively displayed on the chart. In some cases, where a match is not made by the data analysis module 120, the data analysis module 120 may display one or more possibilities to the user and the user may select an appropriate match. In some embodiments, the system 100 may use the captured image data or matched data to determine an assigned seating protocol for the specific class in the corresponding classroom. The individuals in the class may be arranged or re-arranged in the assigned seating protocol based on a specific characteristic.

In some embodiments of the system 100, the data available via the data collection module 110 may be accessible only to users with a certain authorization. In these cases, the display module 116 may have a login function or other identification function that would match the user with the proper level of authorization, thus allowing the user to access certain aspects of the data relating to the physical object while continuing to keep certain aspects to which the user does not have access, hidden or blocked.

In a further example of using the system 100, the chart may represent a casino floor, with slot machines on the casino floor being the objects of interest. Data may be collected with respect to use, payouts, repairs etc. Comparable data may be displayed graphically on each chart. For more detailed information, for example the amount of the last payout or the time of the last payout for a particular slot machine, the user may review the data by drilling down on the specific object or slot machine of interest by selecting the object on the display.

In the preceding description, for purposes of explanation, numerous details are set forth in order to provide a thorough understanding of the embodiments. However, it will be apparent to one skilled in the art that these specific details may not be required. In other instances, well-known elements may be shown in block diagram form in order not to obscure the understanding. For example, specific details are not provided as to whether the embodiments described herein are implemented as a software routine, hardware circuit, firmware, or a combination thereof.

In some cases, embodiments of the system and method can be represented as a computer program product stored in a machine-readable medium (also referred to as a computer-readable medium, a processor-readable medium, or a computer usable medium having a computer-readable program code embodied therein). The machine-readable medium can be any suitable tangible or in appropriate cases, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks. Further, one of skill in the art will understand that the system may be configured on a single computing device or the various modules may be distributed among a plurality of computing devices.

The above-described embodiments are intended to be examples only. Alterations, modifications and variations can be effected to the particular embodiments by those of skill in the art without departing from the scope, which is defined solely by the claims appended hereto.

What is claimed is:

1. A method for object based data management comprising:
providing a chart showing a plurality of objects;
retrieving object based data relating to each object;
determining comparable data for the plurality of objects; and
selectively graphically overlaying the comparable data on the chart.

2. A method according to claim 1 further comprising:
allowing a user to select a specific object of interest; and
displaying object based data for the specific object of interest.

3. A method according to claim 2 further comprising:
allowing a user to edit the object based data for the specific object of interest.

4. A method according to claim 1 wherein the chart is a location based chart.

5. A method according to claim 4 wherein the location based chart is a seating chart.

6. A method according to claim 1 further comprising:
analyzing the comparable data after the data is retrieved.

7. A method according to claim 1 wherein the chart is displayed on a network enabled device.

8. A method according to claim 1 wherein the overlaying the comparable data comprises a visualization of the comparable data with respect to each physical object.

9. A system for physical object based data management comprising:
a data collection module adapted to retrieve object based data relating to each object;
a data analysis module adapted to determine comparable data for the plurality of objects; and
a display module adapted to selectively display the comparable data as a chart.

10. A system according to claim 9 wherein the data analysis module is adapted to analyze the comparable data.

11. A system according to claim 9 wherein the data collection module further comprises an input component adapted to collect data relating to the plurality of objects and store the data in a database.

12. A system according to claim 9 wherein the display module is adapted to display the chart on a network enabled device.

13. A system according to claim 9 wherein the display module is adapted to receive input from a user accessing the system through a network enabled device.

14. A system for automatic processing of attendance comprising:
an input component adapted to capture data relating to students in a classroom;
a data collection module adapted to retrieve and store data from the input component; and
a data analysis module adapted to determine attendance data based on the captured data and pre-existing data relating to the students.

15. A system according to claim 14 wherein the input component is a camera.

16. A system according to claim 14 further comprising a display module adapted to display the attendance data in relation to a seating chart of the classroom.

17. A system according to claim 14 wherein the data analysis module is adapted to aggregate the attendance data for each student over a plurality of class sessions.
